(19) United States
(12) Patent Application Publication
(10) Pub. No.: US 2004/0261055 A1
(43) Pub. Date: Dec. 23, 2004

(54) Predictively processing tasks for building software

(76) Inventors: P. Anders I. Bertelrud, San Mateo, CA (US); Theodore C. Goldstein, Los Altos, CA (US)

Correspondence Address: Ruben S. Bains, Williams, Morgan & Amerson, P.C., Suite 1100, 10333 Richmond, Houston, TX, 77042, US

(21) Appl. No.: 10/660,353

(22) Filed: Sep. 11, 2003

Related U.S. Application Data
(60) Provisional application No. 60/480,300, filed on Jun. 20, 2003.

(51) Int. Cl. G06F 9/44; G06F 9/45

(52) U.S. Cl. 717/106; 717/140

(57) ABSTRACT

A method and apparatus are provided for predictively processing tasks for building software. The method comprises initiating compilation of a file in a processor-based system in advance of a request from a user to compile the file, detecting the user request to compile the file and indicating a status of the compilation of the file in response to detecting the user request.

### BACKGROUND OF THE INVENTION

1. Field of the Invention

The invention generally relates to processing files in a processor-based system, and, in particular, to predictively processing files in an integrated development environment to build software.

2. Description of the Related Art

A wide variety of systems or tools are available to assist software programmers in developing software products. For example, some systems offer an Integrated Development Environment (IDE) in which programmers can create, develop, test, and deploy software applications. Common examples of IDE systems include CodeWarrior™ offered by Metrowerks™ and, Project Builder by Apple®, Visual Studio® offered by Microsoft®.

IDE systems streamline the edit-debug-build development cycle into a powerful and flexible integrated environment. IDE systems and command-line build tools, such as make and jam, typically use internal representations of the tasks that are needed for building a particular software application. The tasks are commonly arranged in a Directed Acyclic Graph (DAG) that allows the system or tool to run the tasks in a desired order for any nodes that are determined to be out-of-date. Individual nodes in the graph may represent tasks such as creating directories, copying resource files, invoking compilers, linkers, and the like.

A conventional approach for software programmers is to write and edit one or more source code files and then to initiate a build to compile these source code files. The build process may be initiated by the programmer in various ways, including through a user interface gesture (e.g., clicking on a “build” button) or by invoking make or jam from the command line. Once the user initiates the build process, an IDE system typically evaluates and processes any tasks that are necessary to bring the software that is under development up-to-date. For example, any source files that have been modified need to be recompiled. Thus, under the conventional approach, no compilation occurs until the user expressly initiates a build. As such, much of the “idle time” during which the user is proof-reading or editing source code goes unused.

The present invention is directed to overcoming, or at least reducing, the effects of, one or more of the problems set forth above.

### SUMMARY OF THE INVENTION

In one aspect of the instant invention, a method is provided for predictively processing tasks for building software. The method comprises initiating compilation of a file in a processor-based system in advance of a request from a user to compile the file, detecting the user request to compile the file, and indicating a status of the compilation of the file in response to detecting the user request.

In another aspect of the instant invention, an apparatus is provided for predictively processing tasks for building software. The apparatus comprises a storage unit communicatively coupled to a control unit. The storage unit has a file stored therein. The control is adapted to initiate compilation of the file in advance of a request from a user to compile the file, detect the user request to compile the file, and indicate a status of the compilation of the file in response to detecting the user request.

In yet another aspect of the instant invention, an article comprising one or more machine-readable storage media containing instructions is provided for predictively processing tasks for building software. The instructions, when executed, enable a processor to initiate compiling of a file including one or more code segments, detect a user request to compile the file, and provide a result associated with the compiling in response to detecting the user request.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a processor-based system for implementing an integrated development environment, in accordance with one embodiment of the present invention;

FIG. 2 is a block diagram of one or more function blocks of an integrated development environment that may be implemented in the processor-based system of FIG. 1;

FIG. 3 is a flow diagram of a method that may be implemented using the integrated development environment of FIG. 2, in accordance with one embodiment of the present invention; and

FIG. 4 illustrates an exemplary flow of a build process in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

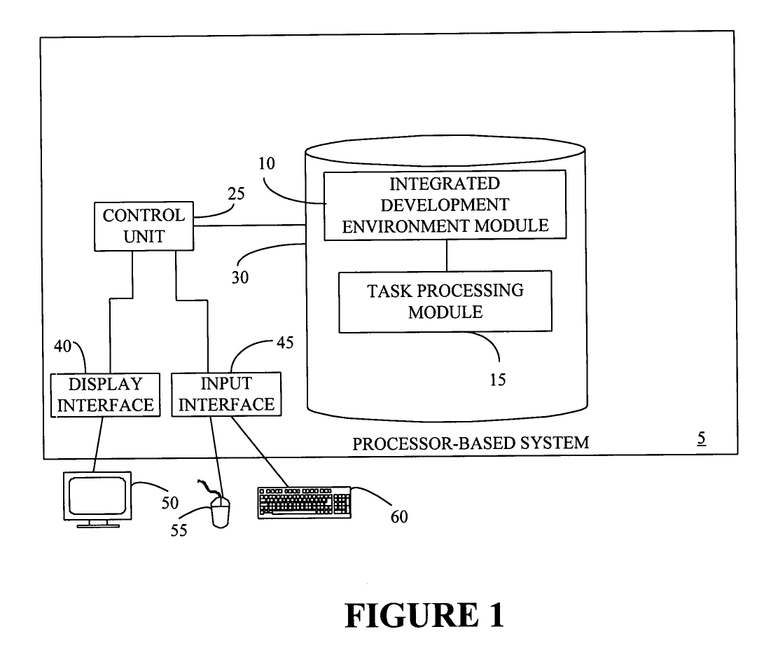

Referring now to FIG. 1, a block diagram of a processor-based system 5 for implementing an Integrated Development Environment (IDE) module 10 is illustrated, in accordance with one embodiment of the present invention. The processor-based system 5 may be any device, such as a computer, having a processor that is capable of processing electronic files containing one or more code segments. Examples of the processor-based system 5 may be a desktop computer, a laptop computer, mainframe computer, or the like. The processor-based system 5 may have an operating system, such as Windows®, Disk Operating System®, Unix®, Linux®, etc., operating therein.

Generally, the IDE module 10, which is described in greater detail below, allows users to develop, test, and deploy software applications. Examples of the IDE module 10 may include one of a variety of commercially available software applications, such as Project Builder, CodeWarrior™, Visual Studio®, or the like. These software applications typically provide a full featured integrated development environment to build software. In a programming context, and as utilized herein, the term “build” refers to putting individual coded components of a program together. The built software may thereafter be tested to determine if it executes as desired. For illustrative purposes, the present invention is described in the context of an integrated development environment, although it should be appreciated that one or more embodiments of the present invention may be applicable to other interactive environments that may be employed to design and develop software applications. One or more embodiments of the present invention may also be applicable to a distributed compilation system where a central computer shares compilation tasks with other networked computers.

In accordance with one embodiment of the present invention, and as described in greater detail below, the system 5 includes a task processing module 15 that predictively processes one or more tasks to bring the software under development up-to-date. As an example, the task processing module 15 performs predictive processing by compiling one or more modified source code files even before the user initiates the build process. The task processing module 15 may be implemented as a standalone module, integrated into the IDE module 10, or may be integrated into some other software module that is capable of interfacing with the IDE module 10. Although the instant invention is not so limited, in the illustrated embodiment, the task processing module 15 is implemented as a background thread that is capable of predictively performing one or more tasks for the IDE module 10, as described in greater detail below.

The system 5 includes a control unit 25 that is communicatively coupled to the storage unit 30. The control unit 25 may be a microprocessor, a microcontroller, a digital signal processor, a processor card (including one or more microprocessors or controllers), or other control or computing devices. The storage unit 30 may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems discussed herein may be stored in the storage unit 30. The instructions, when executed by the control unit 25, cause the system 5 to perform programmed acts.

The system 5 in the illustrated embodiment includes a display interface 40 and an input interface 45. The display interface 40 may be capable of interfacing with a display device 50 to display information on the display device 50. The input interface 45 may be capable of interfacing with input devices, such as a mouse 55 and/or a keyboard 60, to allow the user to input information into the system 5.

For clarity and ease of illustration, only selected functional blocks of the processor-based system 5 are illustrated in FIG. 1, although those skilled in the art will appreciate that the processor-based system 5 may include fewer or additional functional blocks, depending on the implementation. Thus, it should be appreciated that FIG. 1 illustrates one possible configuration of the processor-based system 5 and that other configurations comprising different interconnections may also be possible without deviating from the spirit and scope of the present invention. For example, in one embodiment, the various components of the processor-based system 5 may be interconnected through one or more buses, such as a system bus or a peripheral component interconnect (PCI) bus. Similarly, other arrangements may also be possible, some of which may employ a north bridge and a south bridge, for example.

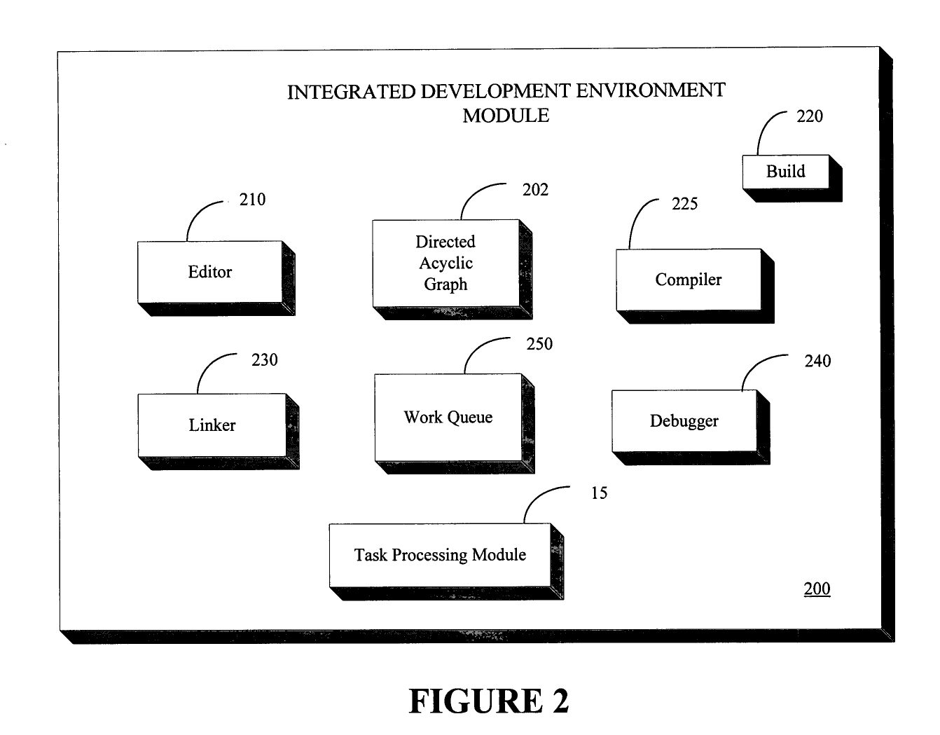

Referring now to FIG. 2, a block diagram of one embodiment of an integrated development environment module 200 that may be employed in the processor-based system 5 is illustrated. As shown in FIG. 2, in the illustrated embodiment, the IDE module 200 includes the task processing module 15 of FIG. 1. Those skilled in the art having the benefit of this disclosure will appreciate that the IDE module 200 and its components (or functional blocks) may be software modules running on the processor-based system 5 of FIG. 1.

The IDE module 200 allows a user to design and develop software applications or products. The initial step of developing the software product(s) generally involves creating a project. A project contains one or more elements that are used to build the software product(s). The project created using the IDE module 200 typically maintains the relationships between various elements contained therein. A project may contain a variety of elements, such as file references, targets and build styles, products, and the like. File references, for example, may include source code files, resource files, libraries, and frameworks. Targets generally describe how to build a particular product, such as a framework, command-line tool, or application, and a build style describes how to create a variation of the target's product. As utilized herein, the term “product” refers to the finished model, and may, for example, include one or more of the linked executable files, associated resource files, etc.

A project may have one or more associated targets. For example, a project for a client-server software package may contain targets that create a client application, a server application, command-line tools that can replace the applications, and a private framework that all the other targets use. By putting these related targets into a single project, it is possible to share files and express dependencies among them. For example, if a project is set-up so that the applications and command-line tools depend on the private framework, the IDE module 200 can determine that it should first build the framework before it builds the applications or tools.

For a given project, the IDE module 200 maintains a list of dependency nodes for each file that participates in the build, where the files may include source files, intermediate files, and product files. Examples of “source files” may include source code files, resource files, library files, headers, and frameworks. Examples of “product files” may include files that appear in the deployable product such as executable files. Examples of “intermediate files” may include files that are neither specified by the user nor end up in the product, such as generated object code files, precompiled headers, and temporary files used by custom shell scripts.

In one embodiment, the IDE module 200 creates the list of dependency nodes based on information from the product type and the target before the build process starts. Each dependency node typically includes a set of references to other nodes on which it depends and a set of actions that may be performed to bring the node up-to-date. In one embodiment, the IDE module 200 utilizes a directed acyclic graph (DAG) 202 to define the dependency relationships between the various nodes in the project. The use of directed acyclic graphs 202 is well known in the art, and thus is not described in detail herein so as to avoid unnecessarily obscuring the instant invention.

The IDE module 200 in the illustrated embodiment includes an editor 210 that provides conventional editing functions for a user to enter and modify file references of a project. As noted, the file references may include source code files, resource files, and the like. The source code may be written in one of several software languages, such as C, C++, Objective-C, Java, Pascal, Fortran, or any other desirable computer language. A user may employ one of the input devices 55, 60 of FIG. 1, for example, to edit the desired computer program(s). Those skilled in the art will appreciate that a computer program may comprise one or more code segments.

Once the desired file references have been created for a given project, the user can build the product under development. This may be accomplished, for example, by invoking the make or jam tools via the command line or through a user interface gesture, such as selecting a build button 220 that may be part of a graphical user interface of the IDE module 200.

The IDE module 200 comprises a variety of tools to build the product, including a compiler 225 and a linker 230. The compiler 225 is adapted to compile one or more of the source files to create object code files. The linker 230 is adapted to link the object files produced by the compiler 225 against the frameworks and libraries listed to create a binary file. As part of the build process, various tools 225, 230 of the IDE module 200 can also process resource files, which define the windows, menus, icons, and the like that are associated with the product under development.

Once the build of the development product is complete, the IDE module 200 provides an executable file that may be executed and tested by the user. The user may use a debugger 240 of the IDE module 200 to, for example, view the various variable values of the executing file, examine the call chain, evaluate expressions, and the like. If any errors are discovered, the user may edit the source code files (or other types of files) to correct the error and then initiate the build process again. This process may be repeated as many times as desired to produce a final software product.

During the development stage of the product, it is not unusual for the user to engage in several iterations of debug and recompile sessions before arriving at the final product. As the user creates new source code (or resource) files or modifies existing source code (or resource) files associated with a project, these files become out-of-date and thus require compiling or recompiling. In one embodiment, an out-of-date file may be identified by comparing the time stamp of the source file to the time stamp of the corresponding source code file (i.e., the compiled file). As each node (e.g., file) becomes out-of-date, the IDE module 200, in one embodiment, puts that node on a work queue 250 so that it can then be processed. Processing one or more out-of-date nodes from the work queue 250 may comprise performing, for example, one or more of the following tasks: creating directories, moving files, invoking the compiler 225 and the linker 230, and the like. In one embodiment, the work queue 250 contains, in dependency-sorted order (based on the information from the directed acyclic graph 202), the set of nodes that are out-of-date. Thus, for example, if a user modifies a header file that is referenced in a source file, in one embodiment, both the header file and the source file may be identified in the work queue 250 because of the underlying dependency.

In accordance with one embodiment of the present invention, the IDE module 200 may identify a node as being out-of-date in the work queue 250 in response to determining that the user has saved (or resaved) a revised version of a source file (e.g., source code file, resource file, etc.) in the storage unit 30 (see FIG. 1). In another embodiment, the IDE module 200 may place a node in the work queue 250 in response to the user exiting the editor module 210 (see FIG. 2) after saving a revised source file.

In an alternative embodiment, the IDE module 200 may identify a node as being out-of-date in the work queue 250 in response to determining that the user desires to compile a portion of a source file currently being edited even before the user completes the editing. For example, a user may designate at least one marker (or waypoint) in the source file to identify the portion of the source file that may be compiled even before the user completes the editing of that file. The marker maybe utilized, for example, to identify a region from the beginning of the source file to a portion that includes the header files. In an alternative embodiment, at least two markers may be utilized to define the portion of the source file that should be precompiled, where the first marker defines the beginning of the portion of the source file and the second marker defines the end. Based on the portion of the source file defined by the marker(s), the IDE module 200 may place a task on the work queue 250, where the compiler module 225 (see FIG. 2) may compile the portion of the source file defined by the marker(s). In an alternative embodiment, the IDE module 200 may create a separate file that includes only that portion of the source file defined by the marker(s) and then place that file on the work queue 250. In alternative embodiments, various other ways may be employed to initiate the compiling of the marked portion of the source file.

As described in greater detail below, the IDE module 200 includes the task processing module 15 that predictively processes one or more tasks in the work queue 250 to bring the software under development up-to-date. That is, the task processing module 15 initiates the processing of the tasks identified in the work queue 250 even before the user initiates a build. The task processing module 15 is able to predictively process the files because the work queue 250 identifies the out-of-date nodes and the order in which these nodes should be processed. In the illustrated embodiment, the task processing module 15 is a thread executing in the background.

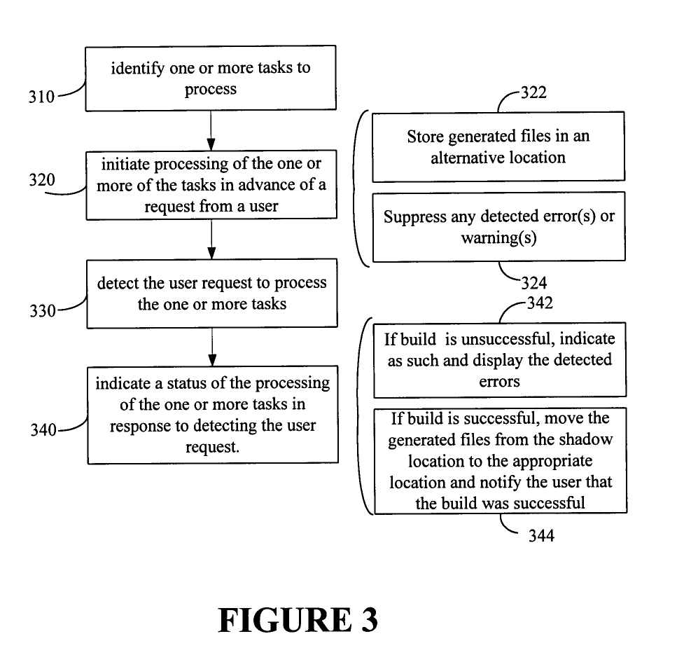

Referring now to FIG. 3, a flow diagram of a method of the present invention is illustrated, in accordance with one embodiment of the present invention. The task processing module 15 identifies (at 310) one or more tasks to process. In the illustrated embodiment, the tasks are associated with building a software application, and thus may involve acts such as moving files and directories, invoking compilers and linkers to respectively compile and link, and the like. In one embodiment, the tasks processing module 15 identifies one or more tasks to process based on the contents of the work queue 250. That is, the work queue 250, which is maintained by the IDE module 200, may contain one or more out-of-date nodes that need to be processed (e.g., the source code files or resource files that have been modified since the last compile, and thus need recompiling) to bring the nodes up-to-date.

The task processing module 15 may identify (at 310) the one or more tasks in one of several ways, depending on the particular implementation. For example, in one embodiment, the task processing module 15 may periodically check the work queue 250 to see if any tasks need processing. In another embodiment, the task processing module 15 may be invoked or awakened each time a new task (or an out-of-date node) is posted in the work queue 250 by the IDE module 200.

The task processing module 15 initiates (at 320) processing of one or more of the identified tasks in advance of a request from a user. That is, the task processing module 15 initiates the build process before it is initiated by the user, through, for example, the command line or by selection of the build button 220 of FIG. 2. In one embodiment, once a particular task has been processed (or an out-of-date node has been updated), that task (or node) is removed from the work queue 250.

As the identified tasks are processed before the user initiates a build, in one embodiment, any files that are generated during the predictive processing are stored (at 322) in a location that is different from the location where the files are typically stored when the build is initiated by the user. For example, object code files produced by compiling source code files may be stored in shadow folders. Storing files in a different location from the normal files allows the user to “roll back” to the results of the most recent user-initiated build process, in case situations where the user decides to undo any of the modifications that triggered the predictive processing. As described below, once the user initiates the build process, any files stored in the alternative location may later be moved to the official location.

In one embodiment, as the identified tasks are processed before the user initiates a build, any error(s) or warning(s) detected during the predictive process are suppressed (at 324). It may be desirable to suppress any errors or warnings detected during the predictive processing so as not to disturb the user until a time the user explicitly initiates the build process.

At the time of the user's choosing, the user may initiate the build process through the command line or through the graphical user interface. Ordinarily, upon detecting the user's request to initiate the build, the IDE module 200 typically executes the tasks identified in the work queue 250 (e.g., processes the out-of-date nodes). However, in accordance with the present invention, because the task processing module 15 may have pre-processed one or more of the tasks associated with the build process, the task processing module 15, upon detecting (at 330) the user request to initiate the build, indicates (at 340) a status of the processing of the one or more tasks. In one embodiment, the status may not be indicated to the user until the build process successfully completes or stops because of errors or warnings. That is, if the tasks associated with the build process have not completed executing by the time the user initiates the build, the status of the processing may not be provided until such execution is complete.

The particular type of status indication provided (at 340) to the user depends on the results of the predictive processing. That is, if the predictive processing was unsuccessful because of error(s)/warning(s) that were detected (and suppressed) during the process, the user may be notified (at 342) of the detected error(s)/warning(s) in response to detecting the request from the user to initiate the build. Thus, if errors are encountered during the predictive processing (such as during the compiling phase, for example), the user, once he initiates the build process, is notified that the compilation could not be completed because of the errors that were found. In one embodiment, the user may be notified of the specific errors that were detected. If, on the other hand, the predictive processing completes successfully, then, in one embodiment, the files stored in the alternative (shadow) locations are moved (at 344) to the official locations and the user is thereafter notified that the build completed successfully. It should be noted that the act of moving the files from the alternative location to the official location may itself be an indication of the status (at 340) of the processing of the tasks. In one embodiment, a message may also be provided to the user indicating that the processing of the tasks was successful.

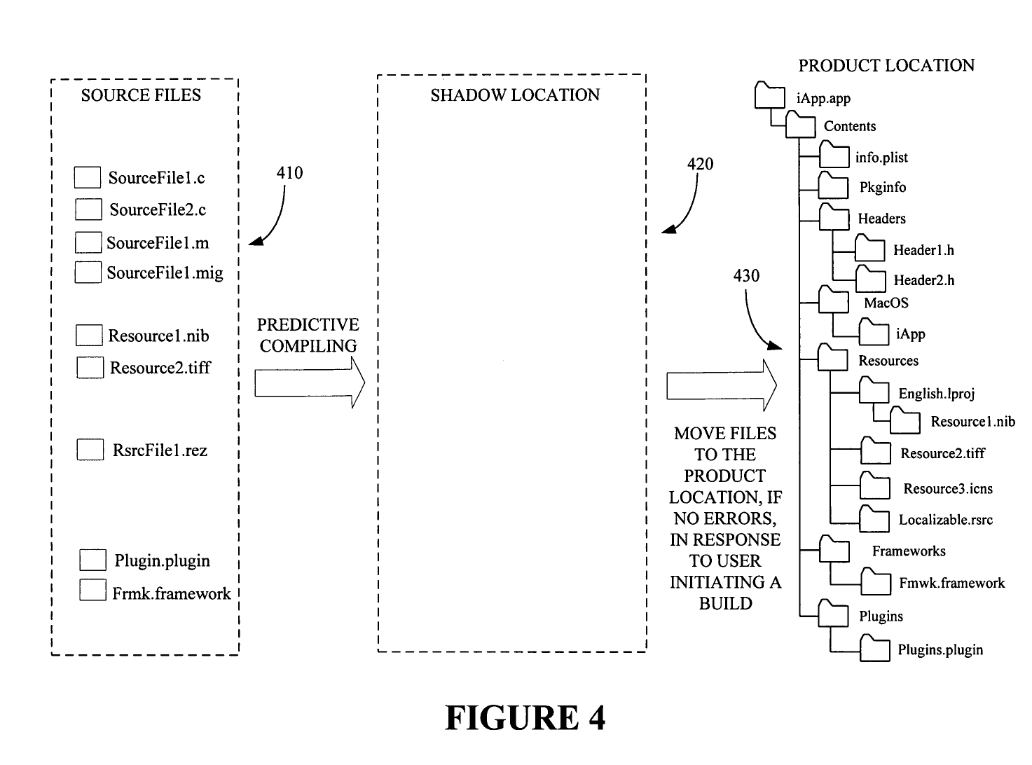

Referring now to FIG. 4, an exemplary flow of a build process is illustrated, in accordance with one embodiment of the present invention. Whenever one or more of the source files 410 are modified by the user, the IDE module 200 updates the work queue 250 to identify the out-of-date node(s). In accordance with one embodiment of the present invention, the task processing module 15, upon detecting an entry in the work queue 250, begins processing the out-of-date node (or the tasks associated with that node) and stores any generated files (e.g., object files generated from source files) in a shadow location 420. The task processing module 15 initiates the processing of the task(s) even before the user performs a gesture to start a build. Assuming that no errors or warnings are discovered during the predictive processing, the files from the shadow location 420 are moved to the product location 430, in response to detecting a gesture from the user to initiate the build.

As described above, one or more embodiments of the present invention are able to predictively process tasks for building software even before the user initiates the build. This results in savings of time because of the pre-processing that occurs before the user actually initiates the build. While the tasks may be processed ahead of time on the assumption that the tasks will process correctly, there is little, if any, harm done if the predictive processing is not successful because the user is no worse off had the user manually initiated the build at a later time. Moreover, even if the predictive processing is not successful because of the detected error(s) or warning(s), the user still may have the benefit of being notified early that the build process is unsuccessful. If the predictive processing is successful, the user may see a potentially significant performance, as some of the more time-consuming processing (e.g., compiling) is done in advance. As a result, in some instances, the build process may appear nearly instantaneous to the user.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
initiating compilation of a file in a processor-based system in advance of a request from a user to compile the file;
detecting the user request to compile the file; and
indicating a status of the compilation of the file in response to detecting the user request.

2. The method of claim 1, wherein initiating compilation of the file comprises compiling the file including one or more code segments to produce an object code file.

3. The method of claim 2, wherein compiling the file comprises compiling one or more code segments in the file to produce an object code file, and further comprising linking the object code file to produce an executable file.

4. The method of claim 1, wherein indicating the status of the compilation of the file comprises at least one of indicating that the compilation was successful and indicating that the compilation was unsuccessful.

5. The method of claim 1, wherein initiating compilation of the file comprises compiling the file in response to determining that the file has been modified.

6. The method of claim 1, wherein determining that the file has been modified comprises determining that the modified file has been saved to a storage unit.

7. The method of claim 1, wherein the file includes one or more code segments, further comprising:
determining that the file has been modified;
identifying the modified file in a work queue; and
initiating the compilation of the file based on the modified file being identified in the work queue.

8. The method of claim 1, wherein indicating the status of the compilation of the file comprises generating one or more files associated with the compilation of the file, storing the one or more generated files in a temporary location, and transferring the one or more files from the temporary location to a different location in response to detecting the user request.

9. An article comprising one or more machine-readable storage media containing instructions that when executed enable a processor to:
initiate compiling of a file including one or more code segments;
detect a user request to compile the file; and
provide a result associated with the compiling in response to detecting the user request.

10. The article of claim 9, wherein the instructions when executed enable the processor to display a message to a user indicating that one or more errors were detected during the compiling.

11. The article of claim 9, wherein the instructions when executed enable the processor to indicate to a user that the compiling was successful.

12. The article of claim 9, wherein the instructions when executed enable the processor to generate a file containing object code based on compiling the file and to store the object code file in a temporary location.

13. The article of claim 12, wherein the instructions when executed enable the processor to move the object code file from the temporary location into a product location based on determining that the compiling of the file was successful and in response to detecting the user request.

14. The article of claim 9, wherein the instructions when executed enable the processor to initiate compiling of the file based on determining that the file was modified.

15. The article of claim 14, wherein the instructions when executed enable the processor to indicate in a work queue that the file has been modified and to initiate compiling of the file in response to detecting the indication.

16. An apparatus, comprising:
means for initiating compilation of a file in a processor-based system in advance of a request from a user;
means for detecting the user request to compile the file; and
means for indicating a status of the compilation of the file in response to detecting the user request.

17. An apparatus, comprising:
a storage unit having a file stored therein; and
a control unit communicatively coupled to the storage unit, the control unit adapted to:
initiate compilation of the file in advance of a request from a user to compile the file;
detect the user request to compile the file; and
indicate a status of the compilation of the file in response to detecting the user request.

18. The apparatus of claim 17, wherein the control unit is adapted to compile a file including one or more code segments to produce an object code file.

19. The apparatus of claim 18, wherein the control unit is adapted to link the object code file to produce an executable file.

20. The apparatus of claim 19, wherein the control unit is adapted to store the executable file in a temporary location and to transfer the executable file from the temporary location to a different location based on detecting the user request.

21. The apparatus of claim 18, wherein the control unit is adapted to at least one of indicate that the compilation was successful and indicate that the compilation was unsuccessful.

22. The apparatus of claim 17, wherein the control unit is adapted to compile the file in response to determining that the file has been modified.

23. The apparatus of claim 17, wherein the control is adapted to:
determine that the file has been modified;
identify the modified file in a work queue; and
initiate the processing of the file based on the modified file being identified in the work queue.

24. A method, comprising:
identifying one or more source files that have been modified in a processor-based system;
initiating processing of at least a portion of the modified source files before receiving a request to process the modified files;
receiving the request to process at least one of the modified files; and
providing a status associated with the processing of the file in response to receiving the request.

25. The method of claim 24, wherein the processor-based system is adapted to execute an integrated development environment module, wherein identifying the one or more files comprises the integrated development environment module placing the one or more of the source files that have been modified in a queue.

26. The method of claim 25, wherein placing the one or more of the source files in the queue comprises placing at least one source file in the queue in response to a user saving the source file to a storage unit.

27. The method of claim 25, wherein placing the one or more of the source files in the queue comprises placing at least a portion of one source file in the queue in response to a user saving the source file to a storage unit using an editor and then exiting from the editor.

28. The method of claim 25, wherein placing the one or more of the source files in the queue comprises placing at least one source file in the queue in response to determining that a user desires to compile at least a portion of the source file as the source file is being edited.

29. The method of claim 25, wherein placing the one or more of the source files in the queue comprises placing at least one source file in the queue in response to determining that the source file includes at least one marker identifying a section of the source file that should be compiled, and wherein initiating processing of at least the portion of the one or more modified files comprises compiling the identified section of the source file.

30. The method of claim 25, wherein initiating the processing of the modified source files comprises causing a background thread to awaken in response to placing the one or more of the source files in the queue, where the background thread thereafter initiates processing of the source files.

31. The method of claim 25, wherein initiating the processing comprises initiating a build process to produce a software application and wherein receiving the request comprises receiving the request to building the software application.

32. The method of claim 25, wherein initiating the build process comprises performing compiling the modified source files to produce object code files and linking the object code files to produce executable files.

33. The method of claim 32, wherein the object code files and the executable files are stored in a first storage location.

34. The method of claim 32, further comprising suppressing at least one of an error and warning that is detected while compiling the modified source files.

35. The method of claim 32, wherein the object code files and the executable files are moved to a different storage location in response to detecting the request and in response to detecting no error or warning.

36. The method of claim 24, wherein identifying one or more source files comprises identifying the one or more source files based on a directed acyclic graph.

37. The method of claim 36, wherein the directed acyclic graph includes a list of dependent files, wherein identifying one or more source files comprises identifying at least one modified source file and another source file that is dependent on the modified source file using the directed acyclic graph.
